(19) United States
(12) Patent Application Publication
(10) Pub. No.: US 2010/0028650 A1
(43) Pub. Date: Feb. 4, 2010

(54) CLOSED-CELL URETHANE SHEET, MANUFACTURING METHOD THEREOF AND WATERPROOF SEALING MATERIALS

(75) Inventors: Koichi KUSAKAWA, Kamakura-shi (JP); Hiromasa Kawaguchi, Tokyo (JP); Noriyuki Sera, Kamiina-gun (JP); Minoru Yoshioka, Ina-shi (JP)

Correspondence Address: Frishauf, Holtz Goodman & Chick, P.C., 16th Floor, 220 Fifth Avenue, New York, NY, 10001-7708, US

(73) Assignee: NHK Spring Co., Ltd., Yokohama-shi (JP)

(21) Appl. No.: 12/511,356

(22) Filed: Jul. 29, 2009

(30) Foreign Application Priority Data
Jul. 31, 2008 (JP) 2008-198043
Mar. 31, 2009 (JP) 2009-086071

(51) Int. Cl. B32B 3/26; B05D 3/02

(52) U.S. Cl. 428/314.4; 427/384; 428/221

(57) ABSTRACT

A method of manufacturing a closed-cell urethane sheet, the method includes the steps of mixing a liquid urethane raw material with thermally expandable microcapsules to obtain a liquid urethane foam raw material, coating the liquid urethane foam raw material on at least one of the opposite surfaces of a releasable substrate to form a urethane raw material sheet, and heating the urethane raw material sheet from the opposite surfaces of the urethane raw material sheet to expand and cure the urethane raw material sheet to obtain the closed-cell urethane sheet.

### CROSS-REFERENCE TO RELATED APPLICATIONS

This application is based upon and claims the benefit of priority from prior Japanese Patent Applications No. 2008-198043, filed Jul. 31, 2008; and No. 2009-086071, filed Mar. 31, 2009, the entire contents of both of which are incorporated herein by reference.

### BACKGROUND OF THE INVENTION

1. Field of the Invention

This invention relates to a closed-cell urethane sheet, to a manufacturing method of the closed-cell urethane sheet and to a waterproof sealing materials to be utilized as a sealing component for the tail lamp of motorcar as seen in the automobile industry, or as a sealing material as seen in the building industry or in the industry of electric household appliances.

2. Description of the Related Art

As well known, soft urethane foam is generally constituted by open cells. Further, even if it is tried to obtain closed-cell urethane foam, the closed-cell urethane foam to be obtained would become low in shrink-resistance. In order to enhance the shrink-resistance of the closed-cell urethane foam, there is no other way but to increase the rigidity of urethane foam, thereby making the urethane foam more resistive to compressive force. However, although it may be possible, in this way, to obtain hard urethane foam, it is impossible in principle to obtain soft urethane foam.

With respect to the techniques for the manufacture of urethane foam, the techniques are disclosed in Jpn. Pat. Appln. KOKAI Publications No. 2005-264048, No. 2006-206793 and No. 6-199978, for instance.

In Jpn. Pat. Appln. KOKAI Publication No. 2005-264048, there is disclosed a technique wherein a specific kind of polyol compound, a polyfunctional isocyanate compound and a foam stabilizer are mixed together and stirred in the-presence of a non-reactive gas to obtain a meringue-like foam dispersion, which is subsequently cured. An object of this publication No. 2005-264048 is to provide a soft polyurethane foam which is excellent in impact absorption and in cushioning properties and is free from the feeling of bottom-out. However, according to the technique disclosed in this publication No. 2005-264048, since the air bubble is introduced into a reaction mixture by means of mechanical agitation, the density of product to be obtained is as high as 0.85 g/cm³ as described in Example 1. Namely, it is impossible to obtain a soft polyurethane foam which is low in density.

In Jpn. Pat. Appln. KOKAI Publication No. 2006-206793, there is disclosed a technique related to the method of manufacturing a polyurethane foam wherein a gas exhibiting a specific solubility is dissolved in a specific kind of polypropylene glycol for obtaining the polyurethane foam. In the case of this Publication No. 2006-206793, the average density of the polyurethane foam to be obtained is 0.6-1.0 g/cm³. Namely, it is impossible to obtain a polyurethane foam of low densities.

In Jpn. Pat. Appln. KOKAI Publication No. 6-199978, there is disclosed a polyurethane foam composition which is featured in that thermally expandable microcapsules are incorporated into a polyurethane composition comprising liquid polyurethane prepolymer and water. An object of this publication No. 6-199978 is to obtain a polyurethane foam which is low in hardness and excellent in abrasion resistance, this polyurethane foam being said to be useful as a paper sheet conveyor roll. Incidentally, in this publication No. 6-199978, the mixing ratio of the thermally expandable microcapsules is as small as 0.25-1.0 part by weight. It may be quite conceivable, in view of this publication No. 6-199978, to incorporate the thermally expandable microcapsules into a liquid urethane raw material for achieving the foaming of the liquid urethane raw materials. However, it has been found by the present inventors that since the thermally expandable microcapsules are caused to expand by the heating thereof wherein the expansion is caused to initiate at first from the surface region of the foaming body, non-uniformity in expansion is caused to develop between the surface region and the core portion of the foaming body, thus resulting in inferior foaming.

### BRIEF SUMMARY OF THE INVENTION

The present invention has been made in view of solving the aforementioned problems and hence one of the objects of the present invention is to provide a method of manufacturing a closed-cell urethane sheet which is lower in density as compared with those of the prior art and another object of the present invention is to provide a waterproof sealing material.

Further objects of the present invention is to provide a closed-cell urethane sheet which is not only lower in density as compared with those of the prior art but also excellent in extensibility and in strength while retaining excellent waterproofness required as a sealing material.

The method of manufacturing a closed-cell urethane sheet according to the present invention (a first invention) is featured in that it comprises the steps of: mixing a liquid urethane raw material with thermally expandable microcapsules to obtain a liquid urethane foam raw material; coating the liquid urethane foam raw material on at least one of the opposite surfaces of a releasable substrate to form a urethane raw material sheet; and heating the urethane raw material sheet from the opposite surfaces of the urethane raw material sheet to expand and cure the urethane raw material sheet to obtain the closed-cell urethane sheet.

The waterproof sealing material according to the present invention (a second invention) is featured in that it is formed of a sheet-like closed-cell urethane to be obtained from the foaming/curing of a liquid urethane raw material incorporated with thermally expandable microcapsules, the sheet-like closed-cell urethane being accompanied, on at least one of the opposite surfaces thereof, with a skin layer exhibiting a contact angle of at least 90°.

The closed-cell urethane sheet according to the present invention (a third invention) is featured in that it is useful as a sealing material and is created from a mixture comprising a liquid urethane raw material and thermally expandable microcapsules, wherein the liquid urethane raw material is an isocyanate-terminated urethane prepolymer representing a reaction product to be obtained from the reaction of dimer acid-based polyol, low molecular glycol and isocyanate, and that the closed-cell urethane sheet is enable to exhibit a contact angle of at least 90°.

The method of manufacturing a closed-cell urethane sheet according to the present invention (a fourth invention) is featured in that it comprises the steps of: mixing a liquid urethane raw material with thermally expandable microcapsules to obtain a liquid urethane foam raw material wherein the liquid urethane raw material is an isocyanate-terminated urethane prepolymer representing a reaction product to be obtained from the reaction of a dimer acid-based polyol; a low molecular glycol and isocyanate; coating the liquid urethane foam raw material on at least one of the opposite surfaces of a releasable substrate to form a urethane raw material sheet; and heating the urethane raw material sheet to expand and cure the urethane raw material sheet to obtain the closed-cell urethane sheet.

### BRIEF DESCRIPTION OF THE SEVERAL VIEWS OF THE DRAWING

FIG. 1A is a cross-sectional view representing a state wherein a liquid urethane foam raw material is coated on the surface of a first film;

FIG. 1B is a cross-sectional view representing a state wherein a second film is laminated on the surface of liquid urethane foam raw material;

FIG. 1C is a cross-sectional view representing a state wherein a skin layer is laminated on the opposite surfaces of closed-cell urethane sheet; and

FIG. 2 is a cross-sectional view of closed-cell urethane sheet having a skin layer laminated on one of the opposite surfaces thereof.

### DETAILED DESCRIPTION OF THE INVENTION

Next, the present invention will be further explained in detail.

### (First and Second Inventions)

In the closed-cell urethane sheet of the present invention, closed-cells and open cells are fundamentally permitted to coexist in the urethane sheet. However, as long as the ratio of the closed-cells is not less than 5%, the physical properties such as the water cut-off property and moisture permeability of closed-cell urethane sheet can be effectively enhanced. Accordingly, in the present invention, the closed-cell urethane sheet is defined as being a urethane sheet having a closed-cell ratio of not less than 5%. Further, with respect to the mixing ratio of the thermally expandable microcapsules to be incorporated into a liquid urethane raw material, it should preferably be confined within the range of 5-30 parts by weight based on 100 parts by weight of polyol to be employed. If the mixing ratio of the thermally expandable microcapsules is less than 5 parts by weight, the effect to lower the density of product would become negligible and the contribution thereof for enhancing the closed-cell ratio would become minimal. On the other hand, if the mixing ratio of the thermally expandable microcapsules is more than 30 parts by weight, the mechanical strength of the product would be deteriorated and the hardness of the product would be increased, and also it would be economically unpreferable. With respect to the thickness of the urethane sheet, it should preferably be confined to the range of 0.1-30 mm. In this case, since it is difficult to decrease the thickness of the urethane sheet to less than 0.1 mm, the lower limit in thickness of the urethane sheet is set to 0.1 mm. Further, when the thermally expandable microcapsules in the urethane sheet are heated, the urethane sheet is caused to expand initiating from the surface region thereof, thereby creating a foamed layer. Since this foamed layer is enabled to act as a heat-insulating layer, it is impossible to effectively expand the urethane sheet provided that the thickness of the urethane sheet is higher than a given value. Therefore, the upper limit in thickness of the urethane sheet is set to 30 mm.

In the present invention, the liquid urethane raw material is constituted by polyol, isocyanate or isocyanate-terminated prepolymer, a foaming agent, a catalyst, a crosslinking agent, etc. A urethane foam can be manufactured by mixing these components with each other.

With respect to specific examples of the polyol useful in this case, it is possible to employ conventionally known polyols such as polyhydric hydroxyl compounds, polyether polyols, polyester polyols, polymer polyols, polyetherester polyols, polyether polyamines, polyester polyamines, alkylene polyols, urea-dispersed polyols, melamine-modified polyols, polycarbonate polyols, acrylic polyols, polybutadiene polyols, dimer acid-based polyols, castor oil-based polyols, olefin-based polyols, phenol-modified polyols, etc. These polyols can be used individually or in a combination of two or more kinds.

Preferable examples of polyols are those having 2-8 in the number of functional group per molecule and 800-12000 in molecular weight. Herein, when the number of functional groups is less than two, it may become difficult to perform the molding of polyurethane foam. When the number of functional group is greater than 8, the physical properties of polyurethane foam to be obtained such as tensile elongation, etc., may be extremely deteriorated. Further, when the molecular weight of polyol is less than 800, the elasticity of polyurethane foam to be obtained may be vanished. When the molecular weight of polyol is greater than 12000, the viscosity of liquid urethane foam raw material would become too high, making it difficult to execute the foaming thereof and hence to execute the molding of polyurethane foam.

With respect to specific examples of polyisocyanate, it is possible to employ, other than MDI-based polyisocyanate, aromatic polyisocyanate such as TDI (tolylene diisocyanate), TODI (tolidine diisocyanate), NDI (naphthalene diisocyanate), etc.; and aliphatic polyisocyanate such as HDI (HNDI) (hexamethylene diisocyanate), IPDI (isohorone diisocyanate), XDI (xylylene diisocyanate), hydrogenated XDI, etc.

Furthermore, it is also possible to employ isocyanate-terminated prepolymer wherein polyol is preliminarily reacted with polyisocyanate.

With respect to the mixing ratio between the polyisocyanate and the polyol, it should preferably be set such that the NCO/OH (index) falls within the range of 0.8-1.4. When this index is lower than 0.8, the physical properties of the polyurethane foam to be obtained such as the water cut-off property and permanent stress would be deteriorated. On the other hand, when this index is higher than 1.4, the crosslinking reaction is caused to proceed excessively, thereby deteriorating the moldability of the polyurethane foam.

As in the case of the conventional manufacturing method, it is also possible, in the present invention, to optionally incorporate additives such as a catalyst, a crosslinking agent, a foam stabilizer, a chain extender, a viscosity reducing agent, etc.

As for the catalyst, it is possible to employ known amine-based catalysts and organometallic catalysts, specific examples thereof including bis(dimethyl aminoethyl) ether, pentamethyl diethylene triamine, N,N-dimethylcyclohexyl amine, N,N-dimethylethanol amine, N,N,N′,N′-tetramethyl hexamethylene diamine, N,N,N′,N′-tetramethyl propylene diamine, N,N,N′,N′-tetramethyl ethylene diamine, triethylene diamine, N-methyl-N′-(dimethylamino)ethyl piperazine, N-methyl morpholine, N-ethyl morpholine, triethyl amine, tin laurate, tin octanate, etc. The mixing ratio of these catalysts may generally be about 0.01-5 parts by weight based 100 parts by weight of the polyol component.

With respect to the crosslinking agent, it is possible to employ those which are relatively low in molecular weight, specific examples thereof including, for example, diols, triols, polyvalent amines, any of these compounds which are appended with ethylene oxide or propylene oxide, triethanol amine, diethanol amine, etc. The mixing ratio of these crosslinking agents may generally be about 0-20 parts by weight based 100 parts by weight of the polyol component. With respect to the foam stabilizer, it is possible to suitably employ silicone-based foam stabilizers which are now generally employed. Incidentally, depending on the performances demanded of polyurethane, it is possible, as required, to incorporate a flame retardant, a filler, an antistatic agent, a colorant, a stabilizer, etc., as long as they do not deviate the objects of the present invention.

The idea of increasing the contact angle of urethane foam as well as the idea of using a hydrophobic raw material for developing the water cut-off property of urethane foam is already disclosed in Jpn. Pat. Appln. KOKAI Publications No. 59-37036 (Document 4) and No. 58-17784 (Document 5). In the present invention, thermally expandable microcapsules are incorporated in a liquid urethane raw material and, at the same time, hydrophobic urethane foam exhibiting a contact angle of not less than 90° is created, thereby making it possible to increase the ratio of closed-cells. As a result, it is now possible to extremely enhance the water cut-off property and moisture impermeability of urethane foam. In the case of the conventional urethane foam-based sealing materials, although they are of open cell type, the hydrophobicity thereof is sufficiently high to develop water cut-off property therein. However, since the conventional urethane foam-based sealing materials are of open cell type, when they are applied as a sealing material to the sealing portion of the tail lamp of automobile for example, moisture is permitted to enter into the interior of this sealing portion because of the high moisture permeability of the conventional urethane foam. As a result, dew formation is caused to generate therein, thereby possibly blurring the window glass. Whereas, when a closed-cell water-sealing material is employed in such a case, the aforementioned problem can be solved. Accordingly, there has been a strong demand for the development of closed-cell type sealing material.

As for the method of creating a urethane foam exhibiting a contact angle of not less than 90°, i.e. the method to create a hydrophobic urethane foam, it is possible to employ the following methods (1) to (3).

(1) A method of incorporating, as a hydrophobic oil additive, a hydrophobic waterproofness-imparting material such as asphalt, a tackiness-imparting resin, petroleum resin, polybutene, wax, etc.

(2) A method of using hydrophobic polyol wherein the molecular skeleton thereof is mainly constituted by carbon atom and hydrogen atom such as olefin-based polyols, polybutadiene polyols, dimer acid-based polyols and castor oil-based polyols.

(3) A method of using, as a foam stabilizer, a silicone compound having, in the molecule thereof, a functional group reacting with isocyanate such as an OH group or amino group, silicone oil having no functional group, or fluorine-based foam stabilizer; or a method of using a large amount of isocyanate having a number of aromatic groups such as diphenyolmethane diisocyanate.

In the present invention, the thermally expandable microcapsules are respectively formed of a synthetic resin capsule in which a liquid or a gas which can be expanded as it is heated such, for example, as propane, butene, normal butane, isobutene, isopentane, normal pentane, hexane, methylene chloride, flons, etc., is contained. As for the synthetic resin, it is possible to employ acrylonitrile, acrylic ester, methacrylic ester, styrene, vinyl acetate, vinylidene chloride, etc. It is also possible to suitably employ, as thermally expandable microcapsules, conventionally known foaming beads such as styrene beads formed of carbon dioxide gas-impregnated styrene resin, polypropylene beads, polyethylene beads, etc.

In the present invention, the method of coating a liquid urethane foam raw material on the surface of a releasable substrate to form a sheet-like layer may be performed by coating the liquid urethane foam raw material on the surface of a silicone resin-coated releasable paper or a silicone resin-coated polyester film, or on the surface of a resin film which is in itself inherently releasable such as polypropylene and polymethylpentene. Further, the liquid urethane foam raw material may be sandwiched between a pair of releasable substrates. Alternatively, the liquid urethane foam raw material may be deposited on the opposite surfaces of a releasable substrate. In the case where the liquid urethane foam raw material is to be deposited only one of the opposite surfaces of a releasable substrate, the other surface thereof is frequently adhered with a polyethylene terephthalate (PET) film. Further, when the liquid urethane foam raw material is sandwiched between a pair of releasable substrates, the deposition of one of the releasable substrates is frequently conducted subsequent to the deposition of a PET film and then the coating of an adhesive on the surface of the layer of liquid urethane foam raw material. In this case, the PET film, the adhesive and the releasable substrate are disposed so as to constitute an adhesive tape.

With respect to the method of coating the liquid urethane foam raw material, it is possible to preferably employ, for example, a roll coater, knife coater, a dice coater and a spray coater.

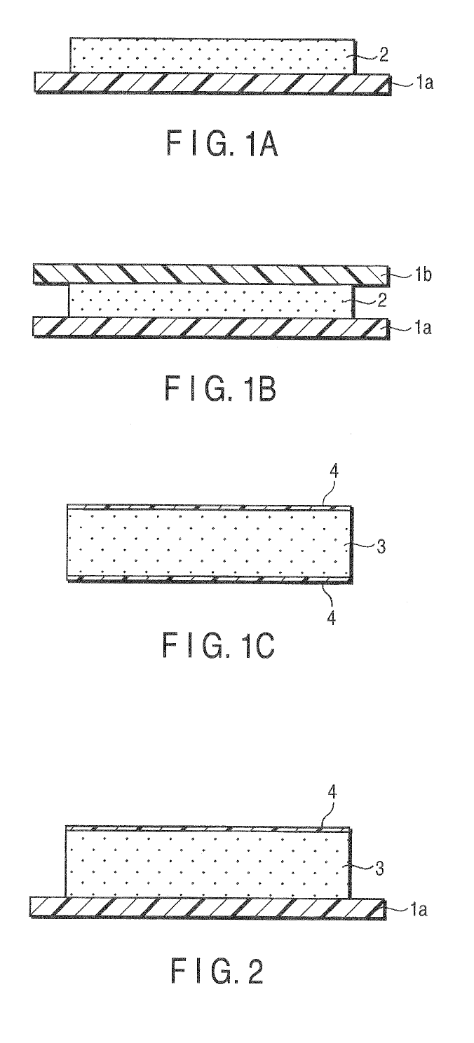

In the present invention, a closed-cell urethane sheet can be manufactured,as shown in FIGS. 1A-1C for instance.

First of all, polyol, isocyanate, a catalyst, thermally expandable microcapsules and other kinds of additives are mixed together to prepare a liquid urethane foam raw material. Then, as shown in FIG. 1A, the liquid urethane foam raw material 2 is uniformly coated on the surface of a first film 1a employed as a releasable substrate. Then, a second film 1b is placed on the surface of the liquid urethane foam raw material 2 (see FIG. 1B). Further, the liquid urethane foam raw material which has been sandwiched between these first and second films 1a and 1b is placed in an oven and heated at a temperature ranging from 60 to 130° C. As a result, the foaming and resinification are permitted to proceed, thereby forming a closed-cell urethane sheet 3. Incidentally, if the heating of the thermally expandable microcapsules is not uniformly executed, the magnification of foaming would become non-uniform, resulting in non-uniformity in thickness of foamed body, thus making it impossible to obtain a sheet-like urethane foam having a satisfactory configuration. Thereafter, the closed-cell urethane sheet 3 which is sandwiched between these first and second films 1a and 1b is taken out and then these first and second films 1a and 1b are peeled off to obtain a product having a skin layer 4 formed on the opposite surfaces thereof (see FIG. 1C).

Incidentally, in the embodiment shown in FIG. 1, it is explained that the first and the second films 1a and 1b are peeled off to obtain a product. However, only second film 1b may be peeled off, leaving the first film 1a as shown in FIG. 2. In this case, the closed-cell urethane sheet 3 carrying the skin layer 4 on one of the surfaces is made integral with the first film 1a. Although not shown in these drawings, the scope of the present invention includes a closed-cell urethane sheet having these first and second films 1a and 1b on the opposite surfaces thereof.

It is preferable in the present invention to further incorporate an auxiliary foaming agent in the liquid urethane foam raw material. In this way, it is possible to obtain a closed-cell urethane sheet which is smoother and more excellent in shape as compared with the case wherein only the thermally expandable microcapsules are incorporated in the liquid urethane raw material. The reason for this may be assumed as follows. Namely, at first the auxiliary foaming agent is enabled to expand in parallel and in two-dimensionally thickness-wise direction and then the thermally expandable microcapsules are enabled to expand in the air bubbles created by the auxiliary foaming agent in such a manner that they are mainly expanded only in the thickness direction.

As for the auxiliary foaming agent, it may be any of foaming agents that can be employed on the occasion of manufacturing ordinary urethane foam, specific examples thereof including, for example, water and volatile organic compounds such as low boiling point hydrocarbons, fluorocarbon compounds, chlorine-based compounds, etc. By making use of these auxiliary foaming agents, it is possible to stably manufacture a low density foamed body.

With respect to the means for expanding the liquid urethane foam raw material by means of heating in the present invention, it can be performed in such a manner that the liquid urethane foam raw material containing thermally expandable microcapsules is coated on the surface of a releasable substrate and then placed in a heating device and heated at a temperature ranging from 60 to 130° C. In this way, the expansion of the microcapsules is enabled to proceed concurrently with the curing of urethane. When the aforementioned auxiliary foaming agent is to be used, it is assumed that the expansion of the coated layer due to the effects of the auxiliary foaming agent is caused to proceed concurrently with the heating at first and then the expansion of the microcapsules is caused to take place in somewhat delayed manner.

### (Third and Fourth Inventions)

Although soft urethane foam is generally formed of open cells, it is possible to create a urethane foam body exhibiting water cut-off properties by making use of hydrophobic raw materials as disclosed in the aforementioned Documents 4 and 5. In this case however, because of the open cells, moisture may be permitted to enter into the interior of this foam body, thereby possibly generating dew formation in the vicinity of a sealed structure depending on the environmental conditions. Therefore, there are strong demands for a closed-cell type sealing material exhibiting excellent water cut-off properties in a case where a sealing material is desired to be used in applications where problems may arise because of dew formation.

For the purpose of realizing a closed-cell type sealing material, the present inventors have been studied for many years on the development of urethane foam wherein thermally expandable microcapsules are contained in a urethane raw material (the first invention). As a result, it has been found out that even if thermally expandable microcapsules are simply incorporated in a liquid urethane raw material, it is still difficult to obtain a urethane foam body exhibiting sufficient elongation and strength. Therefore, it has been already confirmed by the present inventors that when such a urethane foam is employed as a sealing material, it may be split or cut off on the occasion of adhering the sealing material, thus raising problems in practical use thereof.

By taking these facts into consideration, the present inventors have succeeded to invent a closed-cell urethane sheet according to the aforementioned third invention. In the present invention, concurrent with the incorporation of thermally expandable microcapsules, the urethane foam is constructed to have a contact angle of not less than 90°. As a result, the urethane foam thus obtained is increased in ratio of closed-cells, thus making it possible to extremely enhance the water cut-off property and moisture impermeability of the urethane foam.

In the present invention, the liquid urethane foam raw material is constituted by dimer acid-based polyol, the aforementioned isocyanate-terminated prepolymer, a foaming agent, a catalyst, a crosslinking agent, etc. A urethane foam can be manufactured by mixing these components with each other.

With respect to specific examples of the polyol useful in this case, it is possible to employ, for example, dimer acid polyester polyol. Dimer acid is a dimer of unsaturated aliphatic acid such as tall oil aliphatic acid and approximately divalent aliphatic acid. The dimer acid polyester polyol is polyester constituted by this dimer acid and short-chain diol. Other examples of dimer acid-based polyol include polyester which is constituted by dimer diol to be obtained through the hydrogenation of dimer acid and a dibasic acid such as adipic acid, sebacic acid, etc., and alkylene polyol which can be obtained through the addition polymerization of proplylene oxide or ethylene oxide to dimer acid and to dimer diol. By making use of these dimer acid-based polyols, it is possible to obtain urethane foam which is improved in hydrophobicity and enhanced in water cut-off property and moisture impermeability.

In the present invention, the isocyanate-terminated prepolymer is a reaction product between low molecular glycols and isocyanates. Examples of low molecular glycols include polyalkylene glycol, polyester diol, polytetramethylene glycol, polycaprolactone glycol, etc. Examples of isocyanates include MDI-based polyisocyanates; aromatic polyisocyanates such as tolylene diisocyanate, tolidine diisocyanate, naphthalene diisocyanate, etc.; hexamethylene diisocyanate, isohorone diisocyanate, xylylene diisocyanate, hydrogenated XDI, etc. With respect to the molecular weight of low molecular glycol, it should preferably be confined to 300-1000. When the molecular weight of low molecular glycol is confined to this range, the elongation and mechanical strength of urethane foam can be prominently enhanced. With respect to the NCO % of these isocyanate-terminated prepolymers should preferably be confined to 10-25%. When the NCO % of these isocyanate-terminated prepolymers is confined to this range, the elongation and mechanical strength of urethane foam can be improved and, at the same time, the viscosity of urethane raw material can be reduced.

In the present invention, the mixing ratio between the isocyanate-terminated prepolymer and the polyol should preferably be confined to such that the NCO/OH (index) thereof falls within the range of 0.8-1.4. Herein, if this index is lower than 0.8, the physical properties such as the water cut-off property and permanent stress of polyurethane foam to be obtained would be deteriorated. On the other hand, if this index is higher than 1.4, the crosslinking reaction may be excessively advanced, thereby deteriorating the moldability of urethane foam.

In the third and fourth inventions, the details with regard to the catalysts, crosslinking agents, the contact angle of closed-cell urethane sheet, auxiliary foaming agents, the method of coating the liquid urethane foam raw material, the method of manufacturing the closed-cell urethane sheet, and the means for expanding the liquid urethane foam raw material by means of heating are the same as those explained in reference to the first and second inventions.

Next, the examples of the present invention and comparative examples will be explained. These examples are not intended to limit the scope of the present invention. Incidentally, “part” in the present description is based on weight.

### EXAMPLE 1

10 parts of Expancell DU40 (trade name; Nippon Ferrite Co., Ltd.; expandable microcapsules) was added to a liquid urethane raw material containing an auxiliary foaming agent and comprising 100 parts of Excenol 4600 (trade name; Asahi Glass Co., Ltd.; polypropylene glycol 5000 in molecular weight and 34.5 in hydroxyl group value), 15 parts of FTR1600 (trade name; Mitsui Chemicals Co., Ltd.; petroleum resin), 0.9 parts of water, 1 part of NP-405 (trade name; Shinetsu Chemicals Co., Ltd.; silicone foam stabilizer), 0.3 parts of Stanoct SO (tin-based catalyst), and 15.88 parts of T65 (trade name; Nippon Polyurethane Co., Ltd.; expandable microcapsules). Then, the resultant mixture was agitated at a liquid temperature of 35° C. to obtain a microcapsule-containing liquid urethane foam raw material. Then, by making use of a knife coater which was disposed so as to create a gap of 1.8 mm in height over the surface of a polyester-based releasable film, this liquid urethane foam raw material was coated on the surface of the polyester-based releasable film. The resultant layer was heated in a heating oven for 3.5 minutes at a temperature of 70° C. and additionally for 6.5 minutes at a temperature of 130° C. to form a closed-cell urethane sheet (sheet-like urethane product), which was subsequently peeled from the releasable film. The sheet-like urethane product thus obtained was found as having a smooth surface and a thickness of about 10 mm, exhibiting 95° in contact angle, 0.0677 g/cm³ in density and 15% in the ratio of closed-cells. Furthermore, the moisture permeability thereof was 3 g and the water cut-off property thereof was 12 cm.

### COMPARATIVE EXAMPLE 1

By making use of a liquid urethane foam raw material constituted by the same components as those employed in Example 1 except that the thermally expandable microcapsules were not employed and the content of water employed as a foaming agent was changed to 2.4 parts and the content of the T65 was changed to 31.2 parts, a sheet-like urethane product was manufactured. The product thus obtained was found as exhibiting 95° in contact angle, 0.06 g/cm³ in density and 0% in the ratio of closed-cells. Furthermore, the moisture permeability thereof was as high as 5 g and the water cut-off property thereof was as low as 6 cm.

### EXAMPLE 2

100 parts of dimer acid polyester polyol (trade name: Latex 2456; Hitachi Kasei Polymer Co., Ltd.; OH value: 130), 10 parts of Polybutene LV15 (trade name; Shin Nisseki Polymer Co., Ltd.), 0.9 parts of water, 1.5 parts of NP-405 (trade name; Shinetsu Chemicals Co., Ltd.), 0.2 parts of amine catalyst (trade name: DABCO-33LV; Nippon Emulsifier Co., Ltd.), 0.25 parts of Stanoct SO, 30 parts of T65, and 10 parts of Expancell DU40 were mixed together and treated in the same manner as performed in Example 1 to obtain a sheet-like urethane product. The physical features of the product thus obtained are shown in the following Table 1.

### EXAMPLES 3 AND 4

In these Examples 3 and 4, the same kind of liquid urethane foam raw material as employed in Example 2 except that the content of Expancell DU40 was changed to 20 parts and 30 parts, respectively, to obtain sheet-like urethane products. The physical features of these products thus obtained are shown in the following Table 1. As the content of the microcapsules was decreased, the density of the product was proportionally lowered and the ratio of closed-cells was increased. Even if the density of the product was decreased, the water cut-off property of the urethane foam was not substantially changed and the moisture permeability was also kept to a low level.

### COMPARATIVE EXAMPLE 2

By making use of a liquid urethane foam raw material constituted by the same components as those employed in Example 2 except that the thermally expandable microcapsules were not employed and, in order to make the density of foam the same as in that of Example 2, the content of water was changed to 1.6 parts and the content of the T65 was changed to 37.4 parts, a sheet-like urethane product was manufactured. The physical features of the product thus obtained in this comparative example are shown in the following Table 1. In the case of this Comparative Example 2, the ratio of closed-cells was 0%. The water cut-off property and moisture permeability thereof was found inferior as compared with the product of Example 2 having the same density.

TABLE 1

| | | | | | Comparative | |
|---|---|---|---|---|---|---|
| | Examples | | | | Examples | |
| | 1 | 2 | 3 | 4 | 1 | 2 |
| Microcapsules | 10 | 10 | 20 | 30 | — | — |
| (parts) | | | | | | |
| Water (parts) | 0.9 | 0.9 | 0.9 | 0.9 | 2.4 | 1.6 |
| Density | 0.067 | 0.070 | 0.069 | 0.065 | 0.060 | 0.065 |
| (g/cm³) | | | | | | |
| Contact angle | 95 | 98 | 98 | 98 | 95 | 98 |
| (degree) | | | | | | |
| Ratio of | 15 | 24 | 24 | 29 | 0 | 0 |
| closed-cells | | | | | | |
| (%) | | | | | | |
| Moisture | 3 | 1.8 | 1.8 | 1.8 | 5 | 3 |
| permeability | | | | | | |
| (g) | | | | | | |
| Water cut-off | 12 | 60 | 60 | 60 | 6 | 30 |
| property (mm) | | | | | | |

### EXAMPLE 5-9

By making use of the formulation of Example 2, the thickness of coated layer was variously changed, thereby manufacturing a plurality of sheet-like urethane products each differing in thickness. It was made clear that as the thickness of coated layer was increased, the density of products to be obtained became higher. Specifically, when the thickness of the foamed body was increased beyond 30 mm, the density of the foamed body was caused to increase. The reason for this may be assumed as follows. Namely, the thermally expandable microcapsules were caused to expand starting from those existing in the surface region of the coated layer, thereby creating a foamed layer acting as a heat-insulating layer. When the thickness of this heat-insulating layer was increased beyond a predetermined thickness, the residual microcapsules were prevented from effectively expanding. Following Table 2 illustrates relationships among the thickness of coated layer, the thickness of the products and the density of the products.

TABLE 2

| | Examples | | | | |
|---|---|---|---|---|---|
| | 5 | 6 | 7 | 8 | 9 |
| Thickness of | 1.0 | 1.8 | 4.9 | 4.9 | 6.9 |
| coating (mm) | | | | | |
| Thickness of | 6 | 17 | 28 | 28 | 34 |
| product (mm) | | | | | |
| Density (g/cm³) | 0.065 | 0.072 | 0.075 | 0.075 | 0.095 |

Incidentally, in the above Examples and Comparative Examples, the contact angle, the ratio of closed-cells, the moisture permeability and the water cut-off property were measured as follows.

Contact angle: In the measurement of the contact angle, a urethane foam obtained was sandwiched between a pair of aluminum foils and then pressed at a pressure of about 50 kg/cm² while heating them at a temperature of about 200° C. to obtain a thin film thereof. The contact angle of this thin film was then measured by making use of Kyowa contact angle-measuring apparatus.

Ratio of closed-cells: The measurement of the ratio of closed-cells was performed on the basis of ASTMD 2856-70, wherein a test piece 25 mm×25 mm×10 mm in sample size was measured by making use of Beckmann's air comparison type densimeter (Tokyo Science Co., Ltd.).

Moisture permeability: In the measurement of the moisture permeability, a test piece having an outer diameter of 75 mm, an inner diameter of 35.5 mm and a thickness of 10 mm was compressed to 50% and set in a standard bottle. Then, 45 g of silica gel was precisely weighed and placed in the bottle. The resultant bottle was left standing for 24 hours in a thermohygrostat which was kept at a temperature of 85° C. and a humidity of 85%. Any increase in weight after this standing was measured to determine the moisture permeability.

Water cut-off property: In the measurement of the water cut-off property, a test piece having an outer diameter of 60 mm, an inner diameter of 40 mm and a thickness of 10 mm was compressed to 50% and press-fitted in an acrylic plate. Then, water was poured to the test piece to observe the leakage of water. 20 mm of water was additionally poured every 24 hours thereby increasing the pressure of water and the hydraulic pressure which caused the leakage of water was determined as being the water cut-off property.

As described above, according to the present invention, because of the incorporation of thermally expandable microcapsules in a liquid urethane raw material, it is now possible to obtain a closed-cell urethane sheet which is so low in density and so faithfully shaped that could not be realized in the prior art. Further, the closed-cell urethane sheet to be obtained by the present invention is low in moisture permeability and high in water cut-off property or water proofing property. Furthermore, because of the combined use of an auxiliary foaming agent and thermally expandable microcapsules, it is now possible to obtain a closed-cell urethane sheet having an increased smooth surface and a more ordered configuration.

### EXAMPLE 10

10 parts of thermally expandable microcapsules (Expancell DU40 [trade name]; Nippon Ferrite Co., Ltd.) were added to a liquid urethane raw material containing 100 parts of dimer acid polyester polyol (DIC Co., Ltd.; polyester polyol consisting of dimer acid and diethylene glycol and having a molecular weight of 1300 and an OH value of 120), 0.9 parts of water, 1 part of silicone foam stabilizer (NP-405 [trade name]; Shinetsu Chemicals Co., Ltd.), 0.3 parts of Stanoct SO (tin-based catalyst), and 112 parts of isocyanate-terminated prepolymer (DC5600 [trade name]; Nippon Polyurethane Co., Ltd.; a prepolymer consisting of polypropylene glycol having a molecular weight of 600 and MDI). Then, the resultant mixture was agitated at a liquid temperature of 35° C. to obtain a microcapsule-containing liquid urethane foam raw material. Then, by making use of a knife coater which was disposed so as to create a gap of 1.8 mm in height over the surface of a polyester-based releasable film, this liquid urethane foam raw material was coated on the surface of the polyester-based releasable film. The resultant layer was heated in a heating oven for 3.5 minutes at a temperature of 70° C. and additionally for 6.5 minutes at a temperature of 130° C. to form a closed-cell urethane sheet (sheet-like urethane product), which was subsequently peeled from the releasable film. The sheet-like urethane product thus obtained was found as having a very smooth surface and a thickness of about 10 mm, exhibiting 95° in contact angle, 0.0955 g/cm³ in density and 13% in the ratio of closed-cells. Furthermore, this sheet-like urethane product exhibited a tensile strength of 196 kPa, an elongation of 120% and a moisture permeability of 1.3 g and the water cut-off property thereof was 160 mm.

### EXAMPLE 11

A sheet-like closed-cell urethane foam was manufactured by making use of the same kind of liquid urethane foam raw material as employed in Example 1 except that the dimer acid polyester polyol of Example 10 was changed to one having a hydroxyl group value of 80 and the content of isocyanate-terminated prepolymer employed in Example 10 was changed to 81.7 parts. The sheet-like urethane product thus obtained was found as having a very smooth surface and a thickness of about 10 mm, exhibiting 95° in contact angle, 0.0925 g/cm³ in density and 15% in the ratio of closed-cells. Furthermore, this sheet-like urethane product exhibited a tensile strength of 181 kPa, an elongation of 140% and a moisture permeability of 1.3 g and the water cut-off property thereof was 160 mm.

### COMPARATIVE EXAMPLE 3

First of all, a liquid raw material consisting of 100 parts of Excenol 4600 (trade name; Asahi Glass Co., Ltd.; polypropylene glycol 5000 in molecular weight and 34.5 in hydroxyl group value), 15 parts of FTR1600 (trade name; Mitsui Chemicals Co., Ltd.; petroleum resin), 2.0 parts of water, 1 part of NP-405 (trade name; Shinetsu Chemicals Co., Ltd.; silicone foam stabilizer), 0.3 parts of Stanoct SO (tin-based catalyst), and 25.9 parts of T65 (trade name; Nippon Polyurethane Co., Ltd.; expandable microcapsules) was agitated at a liquid temperature of 35° C. to obtain a liquid urethane foam raw material. Then, by making use of a knife coater which was disposed so as to create a gap of 1.8 mm in height over the surface of a polyester-based releasable film, this liquid urethane foam raw material was coated on the surface of the polyester-based releasable film. The resultant layer was heated in a heating oven for 3.5 minutes at a temperature of 70° C. and additionally for 6.5 minutes at a temperature of 130° C. to form a foamed urethane sheet (sheet-like urethane product), which was subsequently peeled from the releasable film. The sheet-like urethane product thus obtained was found as having a very smooth surface and a thickness of about 10 mm, exhibiting 95° in contact angle, 0.094 g/cm³ in density and 0% in the ratio of closed-cells. Furthermore, this sheet-like urethane product exhibited a tensile strength of 113 kPa, an elongation of 120% and a moisture permeability of 4.5 g and the water cut-off property thereof was 70 mm.

### COMPARATIVE EXAMPLE 4

First of all, a liquid urethane raw material consisting of 100 parts of Latex 2456 (trade name; Hitachi Kasei Polyol Co., Ltd.; polyester polyol consisting of dimer acid and diethylene glycol and having a molecular weight of 1000 and a hydroxyl group value of 130), 1.6 parts of water, 1 part of NP-405 (trade name; Shinetsu Chemicals Co., Ltd.; silicone foam stabilizer), 0.2 parts of DABCO-33LV (Nippon Emulsifier Co., Ltd.; amine catalyst), 0.26 parts of Stanoct SO (tin-based catalyst), and 60.2 parts of isocyanate-terminated prepolymer (which is constituted by the aforementioned dimer polyol and T65; NCO %=30) was agitated at a liquid temperature of 35° C. to obtain a liquid urethane foam raw material. Then, by making use of a knife coater which was disposed so as to create a gap of 1.8 mm in height over the surface of a polyester-based releasable film, this liquid urethane foam raw material was coated on the surface of the polyester-based releasable film. The resultant layer was heated in a heating oven for 3.5 minutes at a temperature of 70° C. and additionally for 6.5 minutes at a temperature of 130° C. to form a foamed urethane sheet, which was subsequently peeled from the releasable film. The sheet-like urethane product thus obtained was found as having a very smooth surface and a thickness of about 10 mm, exhibiting 98° in contact angle, 0.091 g/cm³ in density and 0% in the ratio of closed-cells. Furthermore, this sheet-like urethane product exhibited a tensile strength of 147 kPa, an elongation of 110% and a moisture permeability of 3.4 g and the water cut-off property thereof was 70 mm.

Incidentally, the methods of determining the contact angle, the ratio of closed-cells, the moisture permeability and the water cut-off property were the same as described above.

Following Table 3 illustrates the mixing ratio of the microcapsules and water, and physical properties of the products obtained in Examples 10 and 11 and Comparative Examples 3 and 4.

TABLE 3

| | | | Comparative | Comparative |
|---|---|---|---|---|
| | Example 10 | Example 11 | Example 3 | Example 4 |
| Microcapsules (parts) | 10 | 10 | — | — |
| Water (parts) | 0.9 | 0.9 | 2.0 | 1.6 |
| Density (g/cm³) | 0.0995 | 0.0925 | 0.094 | 0.091 |
| Contact angle (degree) | 95 | 95 | 95 | 98 |
| Ratio of closed-cells (%) | 13 | 15 | 0 | 0 |
| Moisture permeability (g) | 1.3 | 1.3 | 4.5 | 3.4 |
| Elongation (%) | 120 | 140 | 60 | 40 |
| Tensile strength (kPa) | 196 | 181 | 55 | 77 |
| Water cut-off property (mm) | 160 | 160 | 70 | 70 |

According to Examples 10 and 11, it is possible to obtain a closed-cell urethane sheet which is sufficiently high in elongation and mechanical strength for practical applications as a sealing material. Further, according to the closed-cell urethane sheets thus obtained, it is possible to secure high water cut-off property and to prominently reduce the moisture impermeability.

What is claimed is:

1. A method of manufacturing a closed-cell urethane sheet, the method comprising the steps of: mixing a liquid urethane raw material with thermally expandable microcapsules to obtain a liquid urethane foam raw material; coating the liquid urethane foam raw material on at least one of the opposite surfaces of a releasable substrate to form a urethane raw material sheet; and heating the urethane raw material sheet from the opposite surfaces of the urethane raw material sheet to expand and cure the urethane raw material sheet to obtain the closed-cell urethane sheet.

2. The method according to claim 1, wherein the liquid urethane foam raw material is formulated to further contain an auxiliary foaming agent in addition to the thermally expandable microcapsules.

3. A waterproof sealing material which is formed of a sheet-like closed-cell urethane to be obtained from the foaming/curing of a liquid urethane raw material containing thermally expandable microcapsules, the sheet-like closed-cell urethane being accompanied, on at least one of the opposite surfaces thereof, with a skin layer exhibiting a contact angle of at least 90°.

4. A closed-cell urethane sheet which is useful as a sealing material and is created from a mixture comprising a liquid urethane raw material and thermally expandable microcapsules, wherein the liquid urethane raw material is an isocyanate-terminated urethane prepolymer representing a reaction product to be obtained from the reaction of dimer acid-based polyol, low molecular glycol and isocyanate, and that the closed-cell urethane sheet is enable to exhibit a contact angle of at least 90°.

5. A method of manufacturing a closed-cell urethane sheet, the method comprising the steps of: mixing a liquid urethane raw material with thermally expandable microcapsules to obtain a liquid urethane foam raw material wherein the liquid urethane raw material is an isocyanate-terminated urethane prepolymer representing a reaction product to be obtained from the reaction of a dimer acid-based polyol, a low molecular glycol and isocyanate; coating the liquid urethane foam raw material on at least one of the opposite surfaces of a releasable substrate to form a urethane raw material sheet; and heating the urethane raw material sheet to expand and cure the urethane raw material sheet to obtain the closed-cell urethane sheet.
